(19) United States
(12) Patent Application Publication
(10) Pub. No.: US 2026/0081985 A1
(43) Pub. Date: Mar. 19, 2026

(54) Contact-Based Network Generation

(71) Applicant: Givingli Inc., West Hollywood, CA (US)

(72) Inventors: Nicole Emrani, Los Angeles, CA (US); Benyamin Green, Los Angeles, CA (US); Avraham Attias, Los Angeles, CA (US)

(21) Appl. No.: 18/885,249

(22) Filed: Sep. 13, 2024

(51) Int. Cl. H04M 1/27453; G06F 16/9535

(52) U.S. Cl. CPC H04M 1/27453; G06F 16/9535

(57) ABSTRACT

A contact management system establishes contact engagement functionality for users early in an account creation project. Before a user account is created, the contact management system uses a prospective system user's phone number to identify likely user contacts and recommend content to the user. Once user accounts are created the contact management system tracks associations between users and stores updates about changes to user associations. User associations are stored in a contact graph that includes metadata about the history and changes to user associations over time. The contact management system uses the stored user association data to generate suggestions and content items for transmitting to users.

### TECHNICAL FIELD

The disclosure generally relates to contact management, and specifically to network generation and early event notification based on updating contact data.

### BACKGROUND

Many systems and applications rely on information about human connections between system users to function effectively. Often, accurate and dynamic data about these user connections can make the difference between a user having a poor experience with a system and the user having a fulfilling and effective interaction with the system. To provide a satisfying user experience, such a system needs to present relevant and tailored content to users as soon as possible in response to new users engaging with the system. Additionally, such a system should maintain up-to-date information about contact networks of existing users to sustain user engagement. However, it is difficult for a system to determine user contacts prior to receiving contact data from the user and changing relationships between human users can be nuanced and difficult to track in real time.

### SUMMARY

A contact management system generates information about likely user connections when a user first engages with the system. During the initial steps of creating a system account for a first user, the contact management system receives a phone number associated with the first user. The system then can access information stored in relation to a set of existing user accounts to determine whether the users of the existing accounts are likely to be contacts of the first user due to phone numbers stored in the user contact lists.

Using this initial information, the system can engage the first user with information relevant to the user's contacts before the first user has finished creating an account with the system. This early contact detection and contact management allows the system to provide an engaging and personalized user experience early on. It also builds user trust and interest in the system and provides incentives for the user to continue with account creation.

Once the user account for the first user has been created, the content management system can access additional data about the contacts of the first user. When the user reopens the application or re-engages with the content management system, the system may receive updated information about the contact list of the user, including information about contacts that have been added, removed, or altered. This information can be used to update a content network maintained by the contact management system.

The contact management system may use the stored contact data and contact network information to provide recommendations to system users. Recommendations may include suggestions to reach out and interact with user contacts due to known or anticipated upcoming events that are relevant to the users. Which events are relevant to the users may be determined using stored information about the nature of the connection and type of contact that exists between two or more users.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a contact management system, in accordance with an embodiment.

FIG. 2 is a high-level bock diagram of a system architecture of a contact management system, in accordance with an embodiment.

FIG. 3A is an example user interface illustrating a step in the process of creating an account with the contact management system, in accordance with an embodiment.

FIG. 3B is an example user interface illustrating a content item suggestion from the contact management system, in accordance with an embodiment.

FIG. 4 is an example contact network, in accordance with an embodiment.

FIG. 5 is a high-level flow chart that describes a process of updating a contact network, in accordance with an embodiment.

FIG. 6 is a block diagram illustrating components of an example machine able to read instructions from a machine-readable medium and execute the instructions in one or more processors, in accordance with an embodiment.

The figures depict an embodiment for purposes of illustration only. One skilled in the art will readily recognize from the following description that alternative embodiments of the structures and methods illustrated herein may be employed without departing from the principles of the systems and methods described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. A letter after a reference numeral, such as “120A,” indicates that the text refers specifically to the element having that particular reference numeral. A reference numeral in the text without a following letter, such as “120,” refers to any or all of the elements in the figures bearing that reference numeral.

### Contact Management System

A contact management system obtains and updates user contact information for a system or organization. The contact information is predicted based on limited user information provided during user account creation. This initial data aids in user engagement and allows the system or organization to provide personalized user content even before the user has provided specific contact information.

Once user accounts are created, the contact data for each user is updated over time to reflect the changing relationships between the user and the user's contacts. This allows the contact management system to tailor content recommendations that will be appropriate and of interest to users in particular relationships. It also enables the contact management system to refrain from recommending content related to user connections that have been dissolved and may be distasteful or unhelpful for the user to engage with.

Together the preliminary contact predictions and the dynamically updating contact network data allows a system or organization using the contact management system to establish user trust, improve user engagement, and retain user interest.

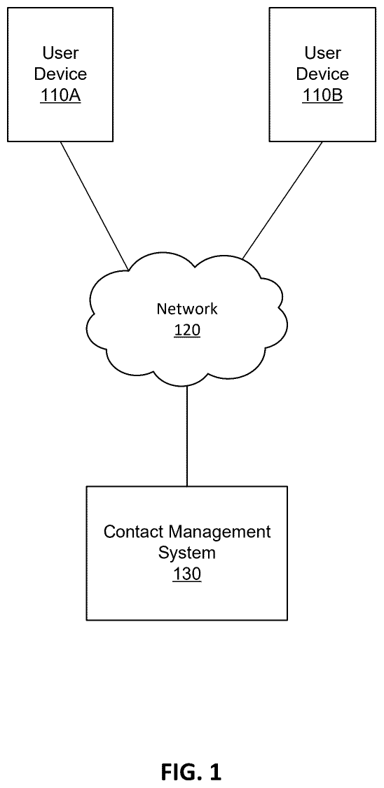

FIG. 1 is a high-level block diagram of a system environment for a contact management system, in accordance with an embodiment. FIG. 1 includes user devices 110, a network 120, and a contact management system 130. For clarity, two example user devices 110A and 110B are illustrated in FIG. 1. Alternate embodiments of the system environment can have any number of user devices 110 as well as multiple contact management systems 130. The functions performed by the various entities of FIG. 1 may vary in different embodiments.

The contact management system 130 manages and stores contact lists for users associated with the system. Contact management may include requesting and updating new contact lists when users log back into the system, updating a contact graph that indicates past and present relationships between users of the system, and recommending content to present to users based on information related to user contacts.

A user may interact with the contact management system 130 via a user device 110. User devices 110 can be personal or mobile computing devices, such as smartphones, tablets, or notebook computers. The user device 110 can also be another form of computing device such as a laptop or desktop computer. In some embodiments, the user device 110 executes a client application that uses an application programming interface (API) to communicate with the system 130 through a network 120.

User devices 110 may interact with the contact management system 130 through client applications or client websites configured to interact with the contact management system 130. Such client applications of the user devices 110 can present information received from the contact management system 130 on a user interface. For example, a client application may present an interface via a user device 110 that directs a user through a process for creating an account and that presents the user with information about user contacts who already have accounts with the contact management system 130.

The user devices 110 can communicate with the contact management system 130 via the network 120, which may comprise any combination of local area and wide area networks employing wired or wireless communication links. In some embodiments, some or all of the communication on the network 120 may be encrypted.

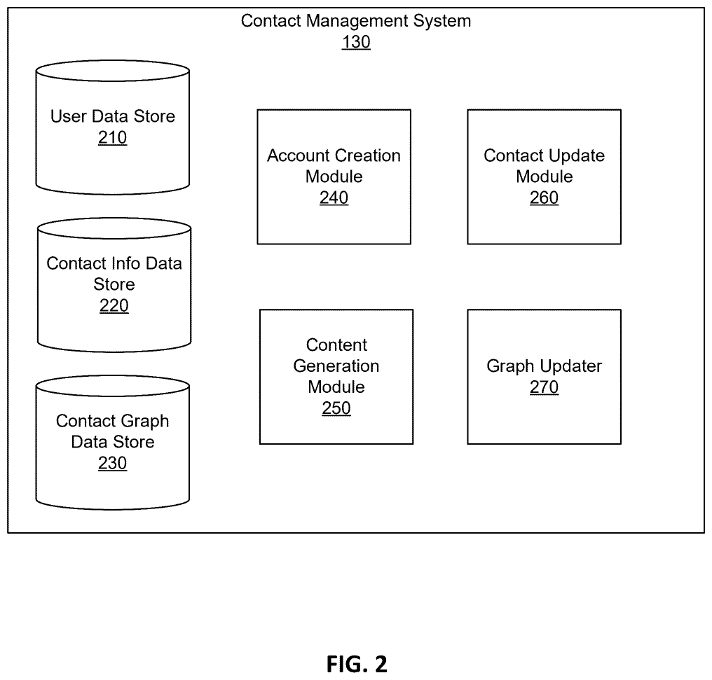

FIG. 2 is a high-level block diagram of a system architecture for the contact management system 130, in accordance with an embodiment. The contact management system 130 includes various modules and data stores for predicting user contacts, tracking relationships between users, and recommending relevant content to users based on their contact data. The contact management system 130 comprises a user data store 210, a contact info data store 220, a contact graph data store 230, an account creation module 240, a content generation module 250, a contact update module 260, and a graph updater 270. Computer components such as web servers, network interfaces, security functions, load balancers, failover servers, management and network operations consoles, and the like are not shown so as to not obscure the details of the system architecture. Additionally, the contact management system 130 may contain more, fewer, or different components than those shown in FIG. 2 and the functionality of the components as described herein may be distributed differently from the description herein. Furthermore, the components of FIG. 2 can be included, additionally or alternatively, in any suitable component shown in FIG. 1.

The user data store 210 stores information about users associated with the contact management system 130. In one embodiment, the user data stored in the user data store 210 includes user profile information and user account settings and preferences for each user's account with the contact management system 130. User information stored in the user data store 210 includes the phone number of the user. Additional stored user information may include a username, full name, birthday, and dates of relevant life events (e.g., wedding anniversary, upcoming graduation, first day of school, work milestone, etc.). The user data store 210 may also store information about user preferences. This can include a user's history of liking content provided by the contact management system, items and content that the user has selected or engaged with in the past, styles of content that the user engages with, and items that are on the user's wish list.

The contact info data store 220 stores contact information for each of the users with accounts associated with the contact management system 130. The contact information associated with a user account may include data about user contacts obtained from a user device 110, for example, once a user has given permission to the contact management system 130 to access contact data on the user device 110. The contact data associated with a user may be in the form of a list of contacts, representing people in some way associated with the user. Such contact data may be the names, affiliations, and phone numbers of other people. For example, contact data may include a list of people and accompanying phone numbers that a user has stored on his cell phone. In some embodiments, contact data may further include additional information about user contacts such as addresses, preferred pronouns, stylistic choices, and contact photos. The contact data can be hashed, encrypted, encoded, tokenized, or protected using any other data protection operation necessary to protect the data and preserve data privacy.

The contact graph data store 230 stores data representing a contact graph. The contact graph includes information about the network of connections among users of the contact management system 130. In one embodiment, nodes in the graph represent users and edges represent relationships between the users. The graph may include different metadata stored at edges. For example, edges may indicate especially strong relationships between two users (e.g., spouses, partners, best friends), familial relationships (e. g,, mother, cousin, niece, granddaughter), work relationships (e.g., boss, coworker), weak relationships (e.g., ex-husband, acquaintance), and service relationships (e.g., plumber, electrician, editor), and other relationship types. This information may be updated over time by the contact update module 260. The changes to a relationship over time may also be recorded as metadata in an edge of the contact graph.

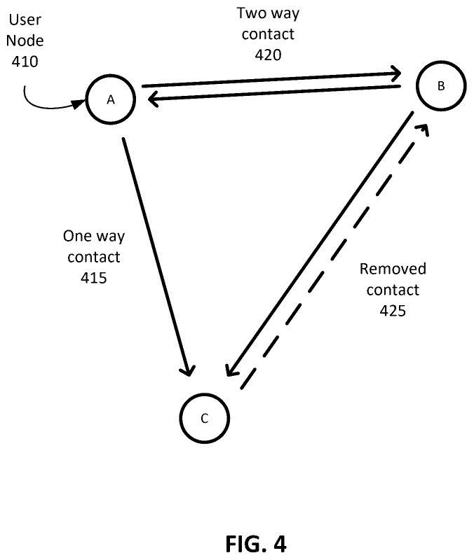

The contact management system uses this stored relationship data to recommend new contacts to users and to recommend content items that users may want to send or gift to their contact. For example, users with an edge in the graph indicating a spousal relationship may be recommended to send anniversary gifts to each other and reminded of an upcoming anniversary, but the system would not recommend that a person's plumber send them an anniversary gift. Additional information and examples of the information stored in the contact graph data store 230 is included in the description of FIG. 4 and in the description of the contact update module 260.

The account creation module 240 manages account creation and user onboarding for the contact management system 130. The account creation module 240 creates user accounts for new users. During the process of account creation, the account creation module 240 may also predict contacts of the new user and provide information to the new user about friends and acquaintances who also use the system. Some steps involved in account creation may involve requesting the user's phone number, comparing the user's phone number against stored contact information of other system users to predict relationships between the new user and existing users, establishing a new user profile, and requesting access to the new user's contact data. Using the information provided by the new user, the account creation module 240 generates a user account associated with the new user and stores the received user data and user account settings in the user data store 210. Additionally, the account creation module 240 may communicate with the contact update module 260 and the graph updated 260 to initiate storage of contact information of the new user in the contact info data store 220 and to update relationship connections by establishing new edges in the contact graph data store 230.

The content generation module 250 generates content items to recommend to users of the contact management system 130. In one embodiment, the contact management system 130 is used to alert users about upcoming dates and important events in lives of their contacts (e.g., upcoming birthdays, graduations, anniversaries, promotions, holidays, etc.). The content generation module 250 accesses information about a user's relationships from the contact graph data store 230 and uses that information to predict content that the user may want to send to a contact. For example, if the contact graph in the contact graph data store 230 indicates that a first user and a second user are good friends, and the information about the second user in the user data store 210 indicates that the second user's birthday is in three days, the content generation module 250 may generate a virtual birthday card and recommend it to the first user to send to the second user.

In addition to determining upcoming dates relevant to certain users, the content generation module 250 uses data from the user data store 210 to predict styles and types of content items that would most appeal to a receiving user. In one embodiment, the content generation module 250 generates virtual greeting cards in styles that are likely to appeal to the known preferences of a user. Additionally, the content generation module 250 can recommend virtual gifts to attach to a virtual card, such as gift cards. In this example, the content generation module 250 would predict the type of gift card that the receiving user would most like based on user data, indicated user preferences, and information about gift cards the user has requested in past interactions. Other types of content that could be generated by the content generation module include videos and photo compilations. In some embodiments, the content generation module 250 may provide some user interface that allows the sending user to adjust and customize a content item before transmitting the content item to a contact.

The content generation module 250 may also keep track of which content items users have already sent to a particular recipient and can suggest different content items to prevent too much repetition. For example, if three friends have already sent a user a graduation gift with a gift card to the user's favorite coffee shop, the content generation module 250 may recommend a different gift card to the next contact based on what the user's second-favorite gift card is.

The contact update module 260 detects changes in user contact data and distributes that information to other modules in the contact management system 130. Each time a user opens an application associated with the contact management system 130 on a user device 110, the contact update module 260 requests the current contact data from the user device 110. The contact update module 260 compares the stored contact information for the user in the contact info data store 220 with the current contact data. If there are changes, the contact update module 260 updates the contact information in the data contact info data store 220. In one embodiment, the contact update module 260 also stores metadata about the changes that have been made to the contact lists. For example, the contact update module may note when a contact has been removed, when many contacts are added at once, and when a contact name or note associated with a phone number is changed.

In one embodiment, the contact update module 260 also allows a user of the contact management system 130 to update contact data through an interface associated with the contact management system 130. For example, a user may indicate through the settings and preferences that a certain contact is merely an acquaintance, and that the user does not want to receive notifications about events associated with that contact. Similarly, the user may indicate that a particular contact is a close friend or a family member, which might prompt the contact management system 130 to send extra notifications about relevant events. This may also help the contact management system 130 to determine appropriate events to recommend for certain relationships. For example, if a user indicates that another user is his mother, then the user may be recommended Mother's Day cards ahead of the holiday.

The graph updater 270 maintains the contact graph stored in the contact graph data store 230. In one embodiment, the contact graph stores contact relationship data in the form of a graph with users represented as nodes and relationships between the users represented by edges. In one embodiment, graph edges are created when one user has a phone number of another user stored. The graph edges may be directed edges, for example, to indicate when only one of the users has the other user stored as a contact.

The graph updater 270 receives updates from the contact update module 260 when the contact update module 260 detects changes in a user's contact information. If the contact update module 260 detected a new contact (e.g., a new phone number added to the user's contacts list), then the graph updater 270 generates new edges to connect the users in the contact graph. If the account creation module 240 creates a new account, the graph updater 270 generates a new node to represent the new user and new edges to represent relationships between the existing users and the new user.

As relationships between users change over time, their contact data may change as well. The graph updater 270 records these changes by annotating the edges of the contact graph. In one embodiment, if a contact is removed entirely from a user's contact list, then the graph updater 270 will delete the edge from the contact graph. In another embodiment, if a contact is removed from a user's contact list, the graph updater 270 removes data associated with the edge or annotates the edge to indicate that although there was once a relationship between the two users, there is no longer a relationship. The contact management system 130 can use this metadata to prevent contacts between the users from being reestablished in the future or to alter the type of content items and events that are recommended for the two users, for instance, either automatically or in response to input from a user.

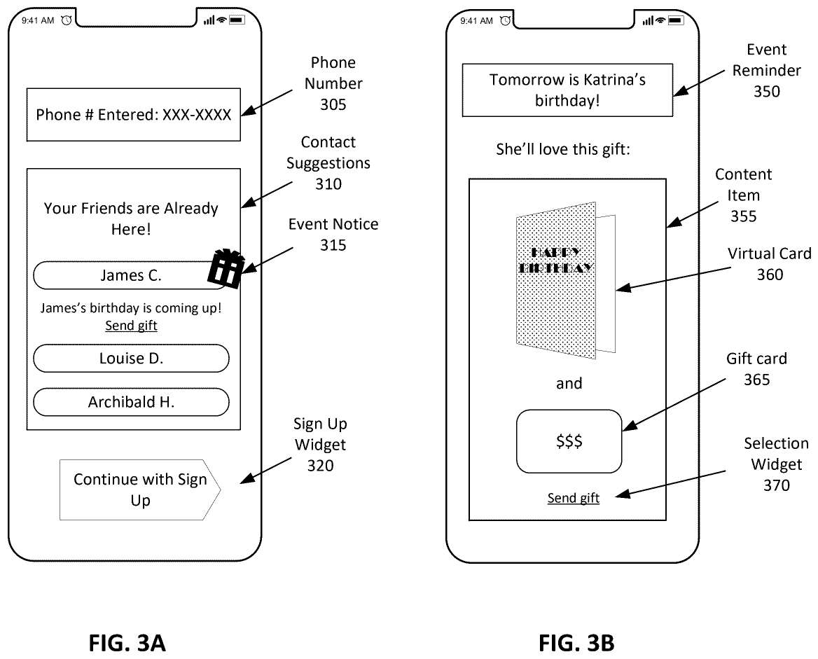

FIG. 3A is an example user interface illustrating a step in the process of creating an account with the contact management system, in accordance with an embodiment. In one embodiment, the first step (or at least a very early step) in the account creation process is to request the new user's phone number. Once the user provides a phone number 305, the account creation module 240 may access the contact info datastore 230 and identify a set of existing users who have the phone number listed as a contact. Before the user has performed any other steps related to content creation, the contact management system 130 can already provide contact suggestions 310 to the user. This demonstrates to the user that their contacts are already using the platform and builds trust and interest in the organization, encouraging the user to continue with the sign-up process. The contact suggestions 310 may include an event notice 315. For example, if a user's contact has a birthday coming up, the contact management system 130 can suggest that the onboarding user use the interface to send a gift or a card to the contact.

FIG. 3B is an example user interface illustrating a content item suggestion from the contact management system, in accordance with an embodiment. FIG. 3B is an example interface of an established user of the contact management system 130. The user interface includes an event reminder 350. The event reminder 350 indicates an upcoming event, such as a birthday, that is associated with a contact of the user. In addition to reminding the user about the upcoming event, the interface includes a content item 355 generated by the content generation module 250. The content item 355 includes information relevant to the relationship between the users and the upcoming event. For example, the content item 355 in the example interface of FIG. 3B includes a virtual card 360 wishing user Katrina a happy birthday and also includes a virtual gift card 365 to a store or restaurant. The interface includes a selection widget 370 the user can select to quickly send the suggested gift to the contact user.

FIG. 4 is an example portion of a contact network, in accordance with an embodiment. The example contact network comprises a contact graph of three user nodes 410, labeled users A, B, and C. The example contact graph in FIG. 4 demonstrates three types of edges representing relationships between users of the contact management system. In one embodiment, a one way contact 415 is a directed edge from node A to node C. This represents a situation in which user A has listed user B as a contact, but user B's contact list does not include user A. In one embodiment, this could also be determined by whether a user has another user's phone number saved in their phone. The example contact graph also includes a two way contact 420 between nodes A and B. This represents a situation in which user A and user B have each other listed as contacts in the contact info data store 220. Finally, the example of FIG. 4 shows one way of representing a removed contact 425. In the example, the dashed connection indicates that there is no longer a directed edge in the contact graph since user C has removed user B from the contact list. However, to keep track of past relationships, the contact graph data store 230 may still include metadata indicating that the two once were contacts.

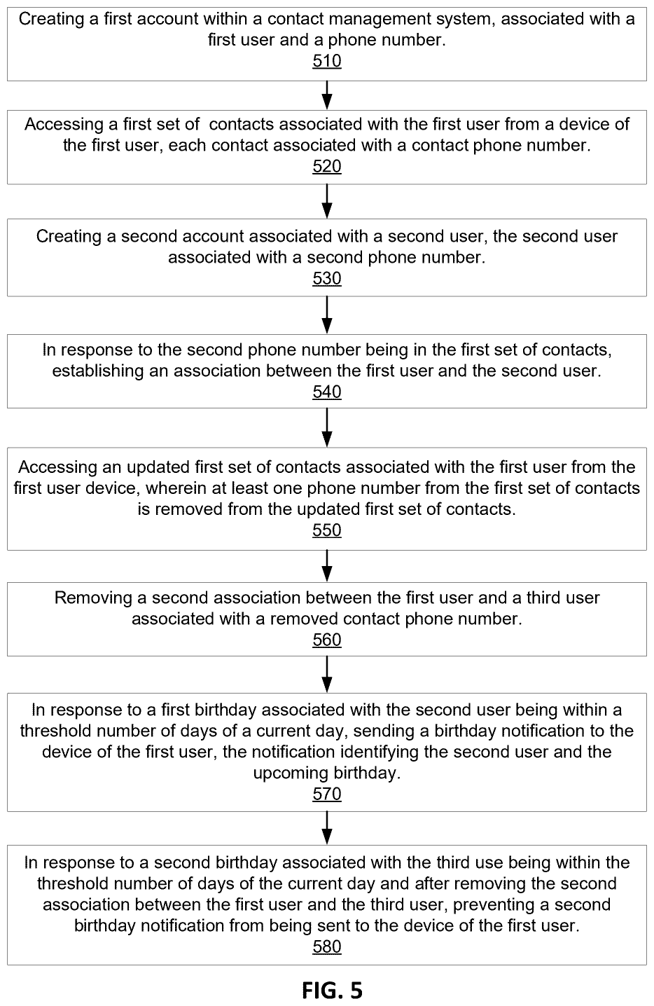

FIG. 5 is a high-level flow chart that describes a process of updating a contact network, in accordance with an embodiment.

The account creation module 240 creates 510 a first account associated with the contact management system 130. The first account is associated with a first user of the contact management system 130 and a first phone number. As part of the account creation, the account creation module 240 accesses 520 a first set of contacts associated with the first user from a first user device 110. Each contact obtained from the first user device 110 is associated with a contact phone number.

The account creation module creates 530 a second account associated with a second user. The second user has an associated second phone number. In response to the second phone number being stored at the contact info data store 220 in the first set of contacts associated with the first user, the graph updater 270 establishes 540 an association between the first user and the second user. This association may be represented by an edge in a contact graph in the contact graph data store 230.

Subsequently, when the first user opens an application of the contact management system, the contact update module 260 accesses 550 an updated first set of contacts associated with the first user (e.g., the updated contact list stored on the phone of the first user). At least one phone number from the first set of contacts is removed from the updated first set of contacts. The removed phone number may be associated with a third user. For example, the first user may have removed a contact from the contact list on the first user device 110. The graph updater 270 removes 560 a second association between the first user and a third user associated with the removed contact number.

In response to a first birthday associated with the second user being within a threshold number of days of the current day, the content generation module 250 generates and sends 570 a birthday notification to the first user at the first user device 110. The birthday notification identifies the second user and informs the first user that the second user has an upcoming birthday. The birthday notification may also include a content item recommending certain styles of virtual birthday cards or virtual gift cards that the first user could choose to send to the second user to celebrate the birthday.

In response to a second birthday associated with the third user being within a threshold number of days of the current day, the contact graph data store 580 detects that the second association between the first user and the third user has been removed from the contact graph, so they are no longer contacts with a relationship that would be expected to send birthday wishes. The contact management system 130 therefore prevents 580 a second birthday notification from being sent to the device of the first user about the upcoming birthday of the third user.

### Additional Configuration Considerations

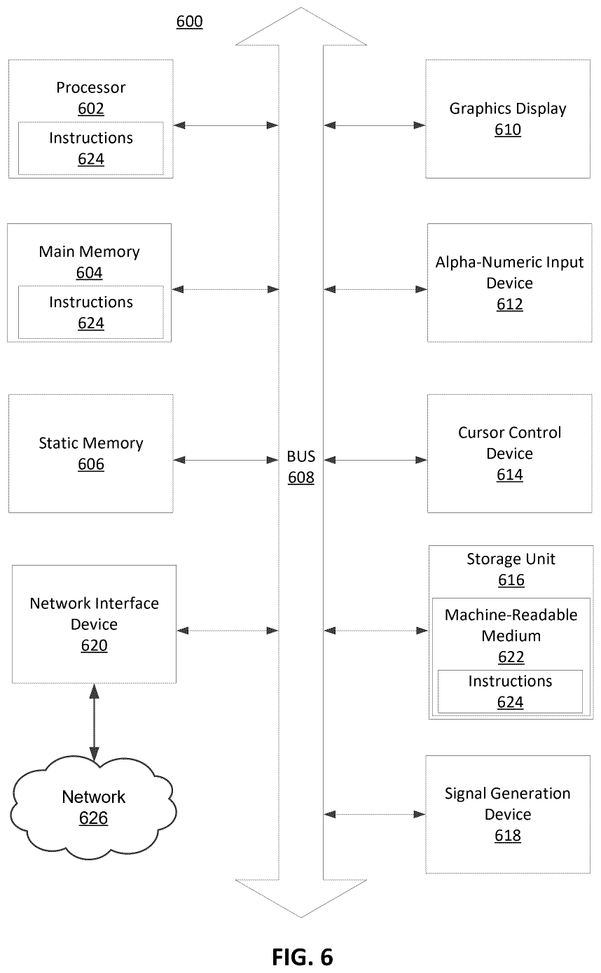

FIG. 6 is a block diagram illustrating components of an example machine able to read instructions from a machine-readable medium and execute them in one or more processors (or controllers). Specifically, FIG. 6 shows a diagrammatic representation of contact management system 130 in the example form of a computer system 600. The computer system 600 can be used to execute instructions 624 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processing units (generally processor 602). The processor 602 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 600 also includes a main memory 604. The computer system may include a storage unit 616. The processor 602, memory 604, and the storage unit 616 communicate via a bus 608.

In addition, the computer system 600 can include a static memory 606, a graphics display 610 (e.g., to drive a plasma display panel (PDP), a liquid crystal display (LCD), or a projector). The computer system 600 may also include alphanumeric input device 612 (e.g., a keyboard), a cursor control device 614 (e.g., a mouse, a trackball, a joystick, a motion sensor, or other pointing instrument), a signal generation device 618 (e.g., a speaker), and a network interface device 620, which also are configured to communicate via the bus 608.

The storage unit 616 includes a machine-readable medium 622 on which is stored instructions 624 (e.g., software) embodying any one or more of the methodologies or functions described herein. For example, the instructions 624 may include instructions for implementing the functionalities of the user data store 210, the contact info data store 220, the contact graph data store 230, the account creation module 240, the content generation module 240, the contact update module 260, and the graph updater 270. The instructions 624 may also reside, completely or at least partially, within the main memory 604 or within the processor 602 (e.g., within a processor's cache memory) during execution thereof by the computer system 600, the main memory 604 and the processor 602 also constituting machine-readable media. The instructions 624 may be transmitted or received over a network 626 via the network interface device 620.

While machine-readable medium 622 is shown in an example embodiment to be a single medium, the term “machine-readable medium” should be taken to include a single medium or multiple media (e.g., a centralized or distributed database, or associated caches and servers) able to store the instructions 624. The term “machine-readable medium” shall also be taken to include any medium that is capable of storing instructions 624 for execution by the machine and that cause the machine to perform any one or more of the methodologies disclosed herein. The term “machine-readable medium” includes, but not be limited to, data repositories in the form of solid-state memories, optical media, and magnetic media.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
creating, by a contact management system, a first account within the contact management system associated with a first user, the first user associated with a first phone number;
accessing, by the contact management system, a first set of contacts associated with the first user from a device of the first user, each contact of the first set of contacts associated with a contact phone number;
creating, by the contact management system, a second account within the contact management system associated with a second user, the second user associated with a second phone number;
in response to the second phone number being included within the first set of contacts, establishing, by the contact management system, an association between the first user and the second user within the contact management system;
accessing, by the contact management system, an updated first set of contacts associated with the first user from the device of the first user, the updated first set of contacts removing at least one contact phone number from the first set of contacts;
removing, by the contact management system, a second association between the first user and a third user associated with a removed contact phone number within the contact management system;
in response to a first birthday associated with the second user being within a threshold number of days of a current day, sending a birthday notification to the device of the first user, the birthday notification identifying the second user and the first birthday associated with the second user; and
in response to a second birthday associated with the third user being within the threshold number of days of the current day and after removing the second association between the first user and the third user, preventing a second birthday notification from being sent to the device of the first user.

2. The method of claim 1, wherein establishing an association between the first user and the second user comprises generating an edge in a stored graph of contacts between existing users, wherein a directed edge between a node representing the first user and a node representing the second user indicates an association between the first user and the second user.

3. The method of claim 2, further comprising:
accessing the stored graph of contacts; and
updating the edges of the stored graph of contacts to represent the updated first set of contacts.

4. The method of claim 3, wherein updating the edges of the stored graph of contacts to represent the updated first set of contacts comprises removing the edge in the graph of contacts that represents an association between the first user and the third user.

5. The method of claim 1, wherein sending a birthday notification to the device of the first user further comprises:
generating, based on stored preferences of the second user, a content item to recommend to the first user to send to the second user, the content item including content and styles that conform to the stored preferences of the second user; and
transmitting the generated content item to the first user with a suggestion to send it to the second user.

6. The method of claim 1 wherein creating a first account comprises requesting permission from the first user to access contact data on the device of the first user.

7-20. (canceled)

21. A contact management system comprising a hardware processor and a non-transitory computer-readable storage medium storing executable instructions that, when executed by the hardware processor, cause the contact management system to perform steps comprising:
creating, by the contact management system, a first account within the contact management system associated with a first user, the first user associated with a first phone number;
accessing, by the contact management system, a first set of contacts associated with the first user from a device of the first user, each contact of the first set of contacts associated with a contact phone number;
creating, by the contact management system, a second account within the contact management system associated with a second user, the second user associated with a second phone number;
in response to the second phone number being included within the first set of contacts, establishing, by the contact management system, an association between the first user and the second user within the contact management system;
accessing, by the contact management system, an updated first set of contacts associated with the first user from the device of the first user, the updated first set of contacts removing at least one contact phone number from the first set of contacts;
removing, by the contact management system, a second association between the first user and a third user associated with a removed contact phone number within the contact management system;
in response to a first birthday associated with the second user being within a threshold number of days of a current day, sending a birthday notification to the device of the first user, the birthday notification identifying the second user and the first birthday associated with the second user; and
in response to a second birthday associated with the third user being within the threshold number of days of the current day and after removing the second association between the first user and the third user, preventing a second birthday notification from being sent to the device of the first user.

22. The contact management system of claim 21, wherein establishing an association between the first user and the second user comprises generating an edge in a stored graph of contacts between existing users, wherein a directed edge between a node representing the first user and a node representing the second user indicates an association between the first user and the second user.

23. The contact management system of claim 22, wherein the instructions, when executed by the hardware processor, cause the contact management system to perform further steps comprising:
accessing the stored graph of contacts; and
updating the edges of the stored graph of contacts to represent the updated first set of contacts.

24. The contact management system of claim 23, wherein updating the edges of the stored graph of contacts to represent the updated first set of contacts comprises removing the edge in the graph of contacts that represents an association between the first user and the third user.

25. The contact management system of claim 21, wherein sending a birthday notification to the device of the first user further comprises:
generating, based on stored preferences of the second user, a content item to recommend to the first user to send to the second user, the content item including content and styles that conform to the stored preferences of the second user; and
transmitting the generated content item to the first user with a suggestion to send it to the second user.

26. The contact management system of claim 21 wherein creating a first account comprises requesting permission from the first user to access contact data on the device of the first user.

27. A non-transitory computer-readable storage medium storing executable instructions that, when executed by the hardware processor, cause the hardware processor to perform steps comprising:
creating, by a contact management system, a first account within the contact management system associated with a first user, the first user associated with a first phone number;
accessing, by the contact management system, a first set of contacts associated with the first user from a device of the first user, each contact of the first set of contacts associated with a contact phone number;
creating, by the contact management system, a second account within the contact management system associated with a second user, the second user associated with a second phone number;
in response to the second phone number being included within the first set of contacts, establishing, by the contact management system, an association between the first user and the second user within the contact management system;
accessing, by the contact management system, an updated first set of contacts associated with the first user from the device of the first user, the updated first set of contacts removing at least one contact phone number from the first set of contacts;
removing, by the contact management system, a second association between the first user and a third user associated with a removed contact phone number within the contact management system;
in response to a first birthday associated with the second user being within a threshold number of days of a current day, sending a birthday notification to the device of the first user, the birthday notification identifying the second user and the first birthday associated with the second user; and
in response to a second birthday associated with the third user being within the threshold number of days of the current day and after removing the second association between the first user and the third user, preventing a second birthday notification from being sent to the device of the first user.

28. The non-transitory computer-readable storage medium of claim 27, wherein establishing an association between the first user and the second user comprises generating an edge in a stored graph of contacts between existing users, wherein a directed edge between a node representing the first user and a node representing the second user indicates an association between the first user and the second user.

29. The non-transitory computer-readable storage medium of claim 28, wherein the instructions, when executed by the hardware processor, cause the hardware processor to perform further steps comprising:
accessing the stored graph of contacts; and
updating the edges of the stored graph of contacts to represent the updated first set of contacts.

30. The non-transitory computer-readable storage medium of claim 29, wherein updating the edges of the stored graph of contacts to represent the updated first set of contacts comprises removing the edge in the graph of contacts that represents an association between the first user and the third user.

31. The non-transitory computer-readable storage medium of claim 27, wherein sending a birthday notification to the device of the first user further comprises:
generating, based on stored preferences of the second user, a content item to recommend to the first user to send to the second user, the content item including content and styles that conform to the stored preferences of the second user; and
transmitting the generated content item to the first user with a suggestion to send it to the second user.

32. The non-transitory computer-readable storage medium of claim 27, wherein creating a first account comprises requesting permission from the first user to access contact data on the device of the first user.
